(19) United States
(12) Patent Application Publication
(10) Pub. No.: US 2023/0120375 A1
(43) Pub. Date: Apr. 20, 2023

(54) BATTERY PACK, POWER TOOL, AND ELECTRIC VEHICLE

(71) Applicant: MURATA MANUFACTURING CO., LTD., Kyoto (JP)

(72) Inventor: Tsuyoshi NAKAMURA, Kyoto (JP)

(21) Appl. No.: 18/081,806

(22) Filed: Dec. 15, 2022

Related U.S. Application Data
(63) Continuation of application No. PCT/JP2021/022633, filed on Jun. 15, 2021.

(30) Foreign Application Priority Data
Jun. 19, 2020 (JP) 2020-105871

(51) Int. Cl. H01M 50/244; H01M 50/249; H01M 10/0525; H01M 50/30

(52) U.S. Cl. CPC H01M 50/244; H01M 50/249; H01M 10/0525; H01M 50/394; H01M 2220/20

(57) ABSTRACT

An attachment member is prevented from coming off from an exterior case. Disclosed is a battery pack including: an exterior case; a battery unit; and an attachment member attached from outside of the exterior case, in which the attachment member has a plurality of claw portions, the attachment member is attached to the exterior case by the plurality of claw portions, a restricting member that restricts a movable range of the claw portion is provided inside the exterior case, and the restricting member is configured as a member separate from the exterior case.

### CROSS REFERENCE TO RELATED APPLICATIONS

The present application is a continuation of PCT patent application no. PCT/JP2021/022633, filed on Jun. 15, 2021, which claims priority to Japanese application no. JP2020-105871, filed on Jun. 19, 2020, the entire contents of which are incorporated herein by reference.

### BACKGROUND

The present application relates to a battery pack, a power tool, and an electric vehicle.

Various attachment members such as buttons are attached to a storage case. These attachment members are required not to fall off from the storage case when an impact or the like is applied. In response to such a request, a structure is described in which a push button does not easily fall off. Specifically, the push button is fitted into a case by a first button assembling operation (insertion in a vertical direction), and the push button and the case are engaged with each other to be in a state of being prevented from coming off in a fitting direction. By the subsequent second button assembling operation (rotation direction), the push button in the above-described come-off preventing state is relatively moved with respect to the case in a direction different from the fitting direction, and the push button and the case are engaged with each other, so that the push button and the case are in a state of being prevented from returning in a relative movement direction, and the push button and the case are in a state of being sufficiently prevented from coming off in the fitting direction.

### SUMMARY

The present application relates to a battery pack, a power tool, and an electric vehicle.

Incidentally, various attachment members are attached to a case that stores a battery unit. The technique described in Background section can also be applied to such an attachment member. However, the technique described has a problem that a claw portion is deformed by impact, and a first button comes off the case and falls off. In addition, there is a problem that an operation space for rotating the claw portion is required.

Therefore, the present application relates to providing a battery pack that reliably prevents an attachment member from coming off from a case according to an embodiment.

In order to solve the above-described problems, the present application, in an embodiment, provides a battery pack including:

an exterior case;

a battery unit; and

an attachment member attached from outside of the exterior case, wherein

the attachment member has a plurality of claw portions,

the attachment member is attached to the exterior case by the plurality of claw portions,

a restricting member that restricts a movable range of the claw portion is provided inside the exterior case, and

the restricting member is configured as a member separate from the exterior case.

The present application, in an embodiment, further provides a battery pack including:

an exterior case;

a battery unit; and

an attachment member attached from outside of the exterior case, wherein

the attachment member has a plurality of claw portions,

the attachment member is attached to the exterior case by the plurality of claw portions, and

a restricting member that restricts a movable range of the plurality of claw portions is integrally provided inside the exterior case, and the restricting member is an elastically deformable rib.

According to an embodiment of the present application, it is possible to reliably prevent the attachment member from coming off the case. The contents of the present application should not be interpreted as being limited by the effects exemplified herein.

### BRIEF DESCRIPTION OF THE FIGURES

FIG. 1 is a perspective view of a battery pack according to an embodiment.

FIG. 2 is an exploded perspective view of the battery pack according to an embodiment.

FIG. 3 is an exploded perspective view of a battery unit according to an embodiment.

FIG. 4 is a view showing an internal configuration of the battery pack according to an embodiment by cutting out a part of the battery pack.

FIG. 5 is an enlarged view of a part of FIG. 4.

FIG. 6 includes views A to E referred to when a configuration example of a pressure regulating valve according to an embodiment is explained.

FIG. 7 includes views A to E that are diagrams for explaining an example of attachment of the pressure regulating valve.

FIG. 8 is an exploded perspective view of a battery pack according to an embodiment.

FIG. 9 is a view showing an internal configuration of the battery pack according to an embodiment by cutting out a part of the battery pack.

FIG. 10 is an enlarged view of a part of FIG. 9.

FIG. 11 includes views A to D referred to when a configuration example of the pressure regulating valve according to an embodiment is explained.

FIG. 12 is a view showing a state in which the pressure regulating valve according to an embodiment is attached.

FIG. 13 includes views A to D for explaining a restricting member according to an embodiment.

FIG. 14 includes views A to D for explaining the restricting member according to an embodiment.

FIG. 15 is a view for explaining the restricting member according to an embodiment.

FIG. 16 is a view for explaining the restricting member according to an embodiment.

FIG. 17 is a view for explaining the restricting member according to an embodiment.

FIG. 18 is a diagram for describing an application example.

FIG. 19 is a diagram for describing an application example.

### DETAILED DESCRIPTION

Hereinafter, one or more embodiments of the present application and will be described below in further detail including with reference to the drawings.

One or more embodiments described hereinafter include favorable specific examples of the present application, and the contents of the present application are not limited thereto.

The members shown in the claims are not specified as the members of the embodiments. In particular, unless otherwise specified, descriptions of dimensions, materials, shapes, relative arrangements, and directions such as up, down, left, and right of the constituent members described in the embodiments are not intended to limit the scope of the present application thereto, but are merely illustrative examples. Note that sizes, positional relationships, and the like of members illustrated in the drawings may be exaggerated for clarity of description, and there are cases where only a part of reference numerals may be illustrated or a part of the illustration may be simplified to prevent complication of illustration. Furthermore, in the following description, the identical names and reference numerals indicate the identical members or members of the same nature, and redundant description thereof will be omitted as appropriate. Furthermore, each element constituting the present application may be achieved in an aspect in which a plurality of elements include the identical member and one member serves as the plurality of elements, or conversely, can be achieved with a function of one member being shared by a plurality of members.

First, an outline of the present application will be described according to an embodiment. The present application relates to a battery pack having a storage case that stores a battery unit. More specifically, the present application relates to a come-off preventing structure for preventing an attachment member from coming off from the storage case and falling off.

It is not preferable that a pressure difference occurs between the inside and the outside of the storage case of the battery pack. For example, when an internal pressure of the storage case is lower than an external pressure, air is sucked into the storage case, and foreign matter such as moisture tends to enter. On the other hand, when the internal pressure of the storage case is higher than the external pressure, the storage case is pushed out to the outside, and there is a concern about safety of the battery pack due to cracks and breakage of the storage case. Thus, in an embodiment, a pressure regulating valve (pressure regulating member) having a porous membrane sheet as an air-permeable membrane is attached to the storage case of the battery pack. Accordingly, the pressure difference between the inside and the outside of the storage case can be eliminated, and the above-described disadvantage can be avoided. In the following, the pressure regulating valve will be described as an example of the attachment member according to an embodiment.

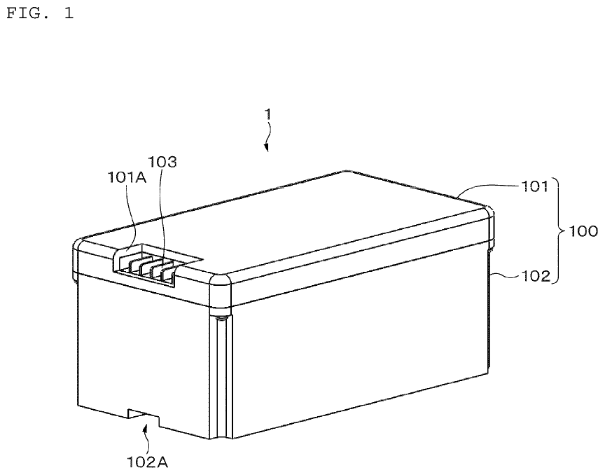

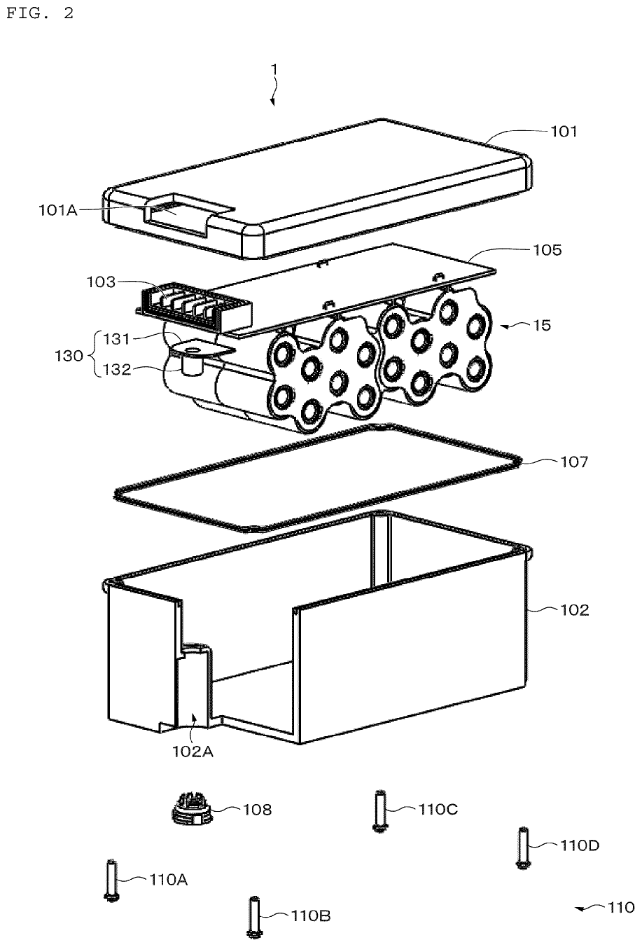

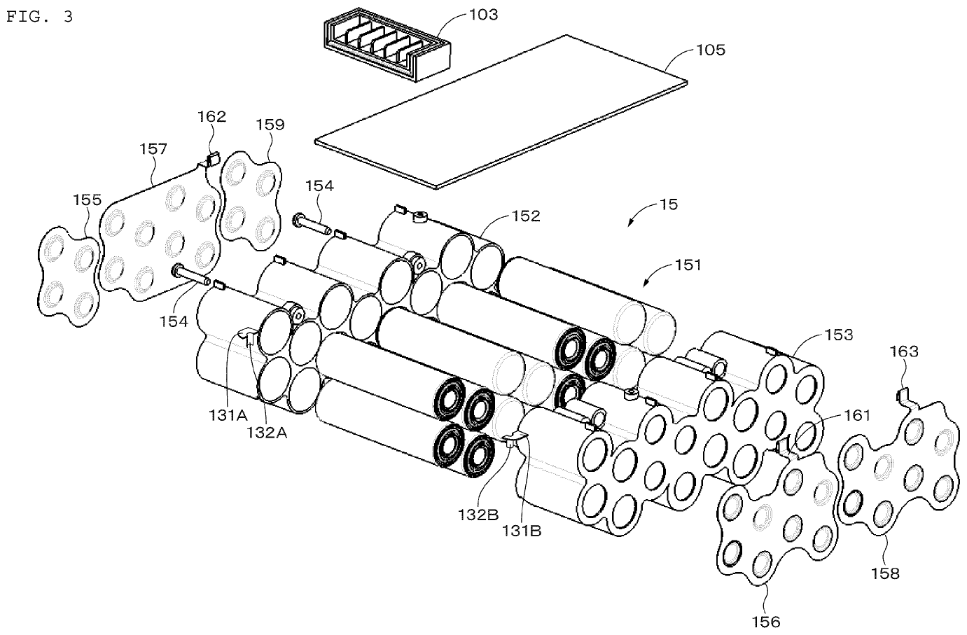

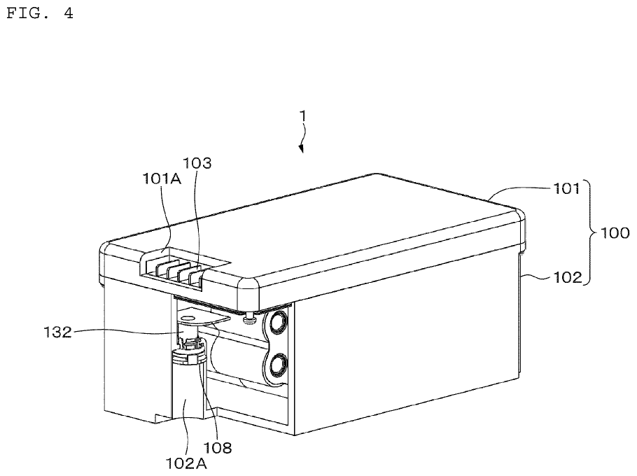

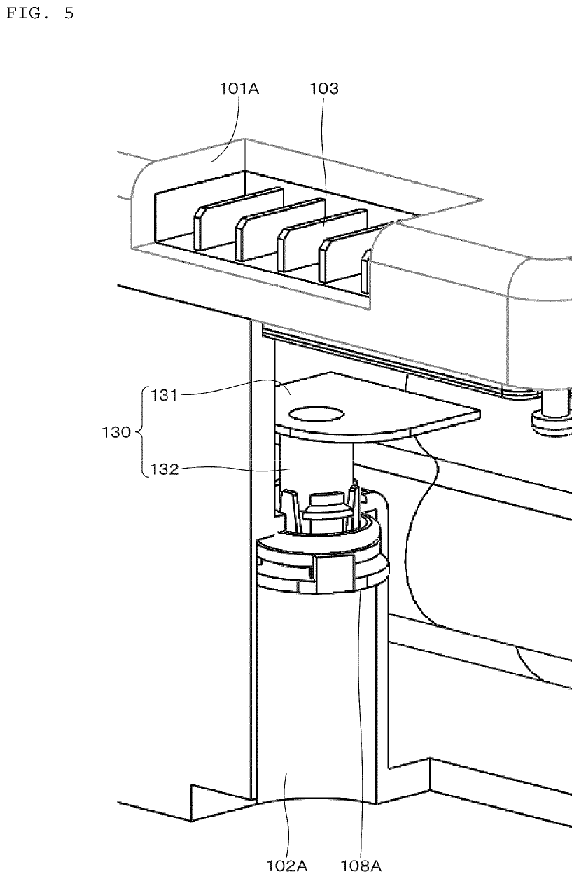

A structure example of a battery pack (battery pack 1) according to a first embodiment will be described with reference to FIGS. 1 to 5. FIG. 1 is a perspective view of the battery pack 1, FIG. 2 is an exploded perspective view of the battery pack 1, FIG. 3 is an exploded perspective view of a battery unit to be described later, FIG. 4 is a view showing an internal configuration of the battery pack 1 by cutting out a part of the battery pack 1, and FIG. 5 is an enlarged view of a part of FIG. 4.

As shown in FIG. 1, the battery pack 1 includes an exterior case 100. The exterior case 100 is made of resin, for example. The exterior case 100 includes an exterior upper case 101 having a rectangular shape in top view and a lid shape, and an exterior lower case 102 having a case shape with an open upper surface. The exterior case 100 according to an embodiment is a single-layered exterior case. A hole portion 101A is formed in the exterior upper case 101. A connector 103 for taking out an output of the battery pack 1 to the outside is exposed via the hole portion 101A. A recess 102A is provided at an end of the exterior lower case 102. A hole portion is formed at a bottom portion of the recess 102A, and a pressure regulating valve to be described later is inserted into and fixed to the hole portion.

A configuration example of the battery pack 1 will be described in detail with reference to FIG. 2. For easy understanding, FIG. 2 shows a state in which a part (near the recess 102A) of the exterior lower case 102 is cut out. In addition to the exterior case 100 (the exterior upper case 101 and the exterior lower case 102) described above, the battery pack 1 includes the connector 103, a circuit board 105 on which an IC (Integrated Circuit) and the like that perform a safety operation of the battery pack 1 are mounted, a battery unit 15, an exterior O-ring 107 formed from an elastic member disposed between peripheral edges of the exterior upper case 101 and the exterior lower case 102, and a pressure regulating valve 108. The circuit board 105 and the battery unit 15 are stored in the exterior case 100. The connector 103, the circuit board 105, and the battery unit 15 are electrically connected to each other, and an output of the battery unit 15 can be taken out to the outside via the connector 103.

The exterior upper case 101 and the exterior lower case 102 are integrated by, for example, fastening vicinities of four corners of each case with four fastening screws (fastening screws 110A to 110D). At the time of integration, the peripheral edge of the exterior upper case 101 and the peripheral edge of the exterior lower case 102 crush the exterior O-ring 107 disposed between the peripheral edges. The exterior O-ring 107 prevents entry of foreign matter such as moisture from the outside.

Next, a configuration example of the battery unit 15 will be described with reference to FIGS. 2 and 3. The battery unit 15 includes a battery 151, a first cell holder 152, a second cell holder 153, a fastening screw 154, and tabs 155 to 159. In an, the first cell holder 152 and the second cell holder 153 correspond to a battery holder.

The battery 151 has one or a plurality of secondary batteries. The battery 151 according to an embodiment includes sixteen lithium ion batteries. More specifically, the battery 151 has a configuration in which four battery blocks having four lithium ion batteries connected in parallel are connected in series. For example, the four lithium ion batteries located on one end side are arranged such that the positive electrode terminal side is directed to the right in the drawing, and the negative electrode terminal side is directed to the left in the drawing. The four lithium ion batteries adjacent to the four lithium ion batteries are arranged such that the positive electrode terminal side is directed to the left in the drawing, and the negative electrode terminal side is directed to the right in the drawing. The four lithium ion batteries adjacent to the four lithium ion batteries are arranged such that the positive electrode terminal side is directed to the right in the drawing, and the negative electrode terminal side is directed to the left in the drawing. The four lithium ion batteries adjacent to the four lithium ion batteries, that is, the four lithium ion batteries on the other end side are arranged such that the positive electrode terminal side is directed to the left in the drawing, and the negative electrode terminal side is directed to the right in the drawing. Naturally, the number of lithium ion batteries (unit cells) included in the battery 151 and the connection mode can be appropriately changed.

The first cell holder 152 and the second cell holder 153 are holders that house and hold the lithium ion batteries and insulate the lithium ion batteries from each other, and are formed of, for example, resin. The first cell holder 152 has a cylindrical storage portion (sixteen storage portions) that stores a half side in the axial direction of the lithium ion battery. The second cell holder 153 has a cylindrical storage portion (sixteen storage portions) that stores a half side (opposite half side) in the axial direction of the lithium ion battery. The first cell holder 152 and the second cell holder 153 are integrated by the fastening screw 154, whereby the battery 151 is housed and held in the first cell holder 152 and the second cell holder 153. At end portions of the first cell holder 152 and the second cell holder 153, a hole portion for welding the positive electrode terminal or the negative electrode terminal and an appropriate tab is formed.

As shown in FIG. 2, a restricting portion 130 is provided on one side surface of the cell holder. The restricting portion 130 has a plate-like portion 131 protruding from one side surface of the cell holder and a restricting member 132 extending downward from the plate-like portion 131. The restricting member 132 according to an embodiment has, for example, a columnar shape with a hollow inside. The restricting member 132 is provided inside the exterior case 100, and is configured as a member separate from the exterior case 100.

The plate-like portion 131 can be divided into two plate-like portions (plate-like portion 131A and plate-like portion 131B) from the vicinity of the center. The restricting member 132 can also be divided into two restricting members (restricting member 132A and restricting member 132B). The plate-like portion 131A and the restricting member 132A are integrally formed, and are provided at a part of an outer surface of the first cell holder 152, specifically, at a predetermined position on the side surface as shown in FIG. 3. The plate-like portion 131B and the restricting member 132B are integrally formed, and are provided at a part of an outer surface of the second cell holder 153, specifically, at a predetermined position on the side surface as shown in FIG. 3. By integrating the first cell holder 152 and the second cell holder 153, the plate-like portion 131A and the plate-like portion 131B are integrated to form the plate-like portion 131. By integrating the first cell holder 152 and the second cell holder 153, the restricting member 132A and the restricting member 132B are integrated to form the restricting member 132.

The tab 155 is a metal plate connected to the negative electrode terminals of the four lithium ion batteries on one end side. The tab 156 is a metal plate connected to the positive electrode terminals of the four lithium ion batteries on one end side and the negative electrode terminals of the four lithium ion batteries that are second from one end side. The tab 157 is a metal plate connected to the positive electrode terminals of the four lithium ion batteries that are second from one end side and the negative electrode terminals of the four lithium ion batteries that are third from one end side. The tab 158 is a metal plate connected to the positive electrode terminals of the four lithium ion batteries that are third from one end side and the negative electrode terminals of the four lithium ion batteries on the other end side (fourth from one end side). The tab 159 is a metal plate connected to the positive electrode terminals of the four lithium ion batteries on the other end side. A connection portion 161 of the tab 156, a connection portion 162 of the tab 157, and a connection portion 163 of the tab 158 are each connected to an appropriate portion of the circuit board 105.

As shown in FIGS. 4 and 5, the restricting member 132 is disposed at the bottom portion of the recess 102A (portion opposite to an open end of the recess 102A). When the pressure regulating valve 108 inserted from the open end of the recess 102A is inserted into the restricting member 132, the pressure regulating valve 108 is attached to the exterior lower case 102.

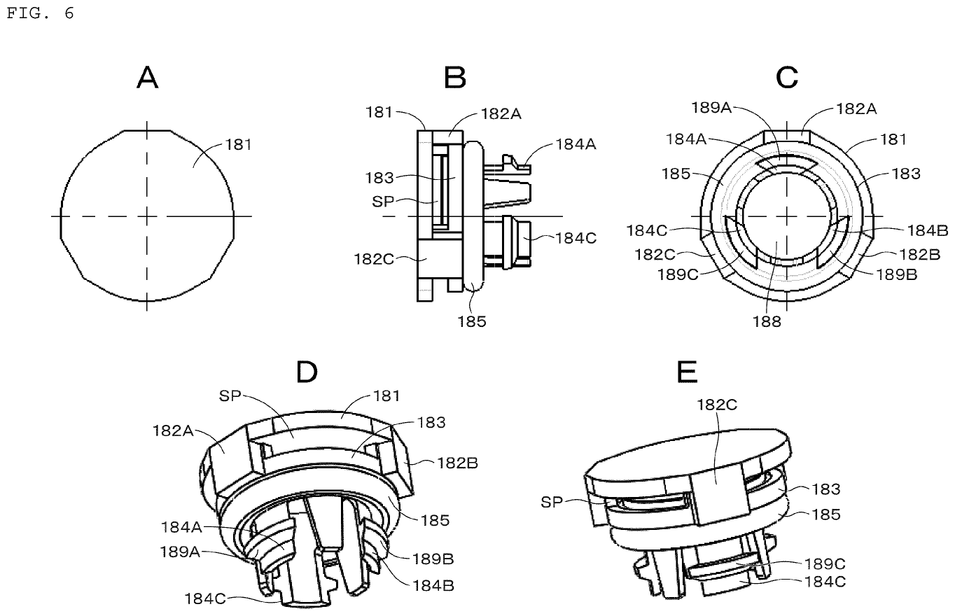

Next, a configuration example of the pressure regulating valve 108 will be described with reference to FIGS. 6A to 6E. FIG. 6A is a bottom view of the pressure regulating valve 108, FIG. 6B is a side view of the pressure regulating valve 108, FIG. 6C is a front view of the pressure regulating valve 108, FIG. 6D is a perspective view of the pressure regulating valve 108 viewed from a predetermined direction, and FIG. 6E is a perspective view of the pressure regulating valve 108 viewed from a direction different from the predetermined direction (direction opposite to the predetermined direction).

Each component of the pressure regulating valve 108 is formed of, for example, resin unless otherwise specified. The pressure regulating valve 108 has a circular section, specifically, has a circular plate-like base 181. Three protrusions 182A to 182C are formed at a peripheral edge of one main surface of the base 181. The three protrusions 182A to 182C are formed at intervals of approximately 120 degrees.

The three protrusions 182A to 182C support a ring-shaped annular member 183. With such a configuration, a gap SP communicating with the outside is formed between the base 181 and the annular member 183. Three fitting claws 184A to 184C which are examples of a plurality of claw portions are formed from a position close to an inner peripheral edge of a surface opposite to an opposing surface of the annular member 183 facing the base 181. The three fitting claws 184A to 184C are arranged along a sectional shape of the pressure regulating valve 108, and are formed, for example, at intervals of approximately 120 degrees. The fitting claws 184A to 184C have flexibility to slightly deflect inward.

A locking piece 189A extending outward is formed near a center of the fitting claw 184A. A locking piece 189B extending outward is formed near a center of the fitting claw 184B. A locking piece 189C extending outward is formed near a center of the fitting claw 184C.

An air-permeable membrane (porous membrane sheet) 188 is attached to the annular member 183 so as to cover the inside of the annular member 183. The air-permeable membrane 188 is attached to the annular member 183 by adhesion, for example.

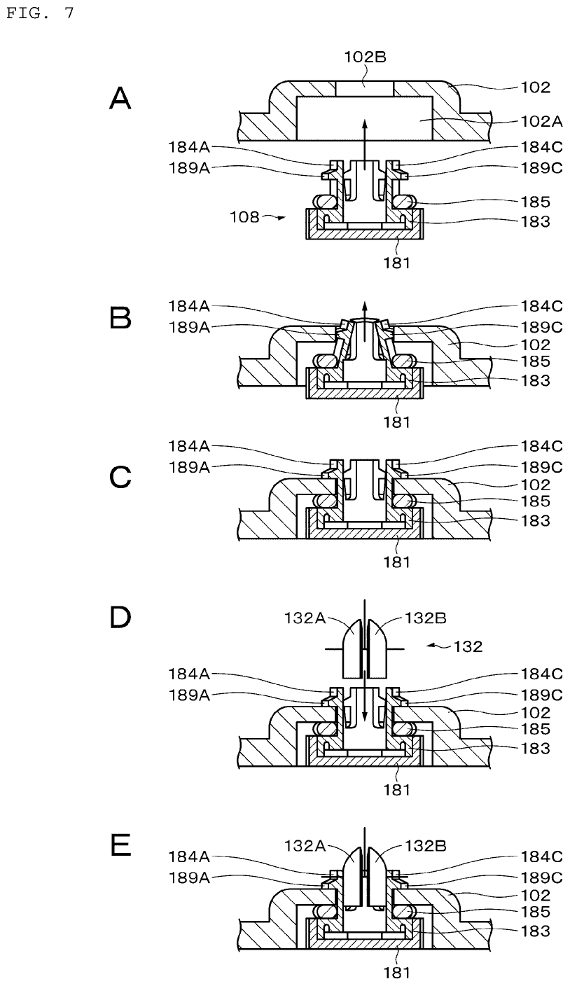

Next, an attachment example of the pressure regulating valve 108 will be described with reference to FIGS. 7A to 7E. As shown in FIG. 7A, the pressure regulating valve 108 is inserted into the recess 102A from the outside of the exterior lower case 102 in a state in which an O-ring 185 is placed on the upper side of the annular member 183. Then, the three fitting claws 184A to 184C are inserted into a hole portion 102B formed in a bottom portion (depth side) of the recess 108A while the three fitting claws 184A to 184C are deflected. When the upper pressure regulating valve 108 is inserted to a certain extent or more, the fitting claws 184A to 184C are returned by a restoring force, and the state shown in FIG. 7C is obtained. As shown in FIG. 7C, the exterior lower case 102 is sandwiched between the locking pieces 189A to 189C and the O-ring 185. Since the locking pieces 189A to 189C serve as stoppers, the pressure regulating valve 108 is prevented from being detached from the exterior lower case 102.

In the state shown in FIG. 7C, the structure for preventing the pressure regulating valve 108 from coming off is insufficient. That is, the fitting claws 184A to 184C deflect inward by an impact applied at the time of falling or the like, and this may cause the pressure regulating valve 108 to come off from the exterior lower case 102. Thus, in an embodiment, the restricting member 132 restricts a movable range of the plurality of fitting claws 184A to 184C.

Specifically, as shown in FIG. 7D, when the first cell holder 152 and the second cell holder 153 are stored in the exterior case 100, the restricting members 132A and 132B are inserted into the fitting claws 184A to 184C. As a result, as shown in FIG. 7E, the restricting member 132 (restricting members 132A and 132B) is disposed inside the fitting claws 184A to 184C. A space in which the fitting claws 184A to 184C deflect inward can be eliminated by the restricting member 132. Since the movable range of the fitting claws 184A to 184C is limited by the restricting member 132, the fitting claws 184A to 184C do not deflect inward by an impact applied at the time of falling or the like, so that the pressure regulating valve 108 can be reliably prevented from coming off from the exterior case 100.

Air permeability inside and outside the exterior case 100 is secured via the air-permeable membrane 188 and the gap SP of the pressure regulating valve 108 attached to the exterior case 100. Therefore, it is possible to avoid the above-described disadvantage caused by the pressure difference between the inside and the outside of the storage case.

The pressure regulating valve 108 can be attached to the exterior case 100 only by a simple operation of inserting the pressure regulating valve 108. Since the deflection of the fitting claw of the pressure regulating valve 108 is restricted by the restricting member formed of a member different from the exterior case, it is possible to reliably prevent the pressure regulating valve 108 from coming off from the exterior case 100. Therefore, it is not necessary to perform a plurality of operations accompanied by an operation such as rotation in order to realize the structure for preventing the pressure regulating valve 108 from coming off. In general, it is not preferable that the pressure regulating valve 108 is visible from the viewpoint of designability and erroneous operation. Thus, it is preferable that the pressure regulating valve 108 is attached to the depth side of the recess 102A as in an embodiment. In such a case, the operation of rotating the pressure regulating valve 108 becomes difficult, and it is also necessary to enlarge the recess 102A in order to secure a space. However, according to an embodiment, since it is only necessary to perform the operation of inserting the pressure regulating valve 108, it is not necessary to enlarge the recess 102A, and when the pressure regulating valve 108 is attached deep in the recess 102A so as to be inconspicuous, difficulty in the operation does not occur. It is only necessary to insert the pressure regulating valve 108, and it is not necessary to use a jig for attaching the pressure regulating valve 108.

Next, a second embodiment will be described. In the description, the same or similar configurations in the above description are denoted by the same reference numerals, and redundant description is appropriately omitted. Unless otherwise stated, the matter described in the first embodiment can be applied to the second embodiment. Schematically, the second embodiment is different from the first embodiment in that a restricting portion 130 is provided.

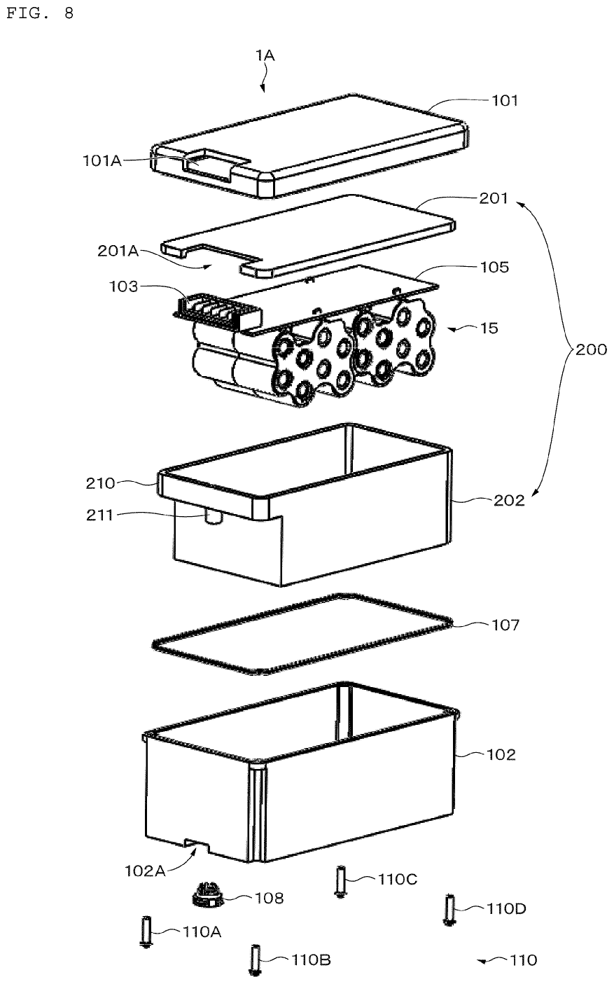

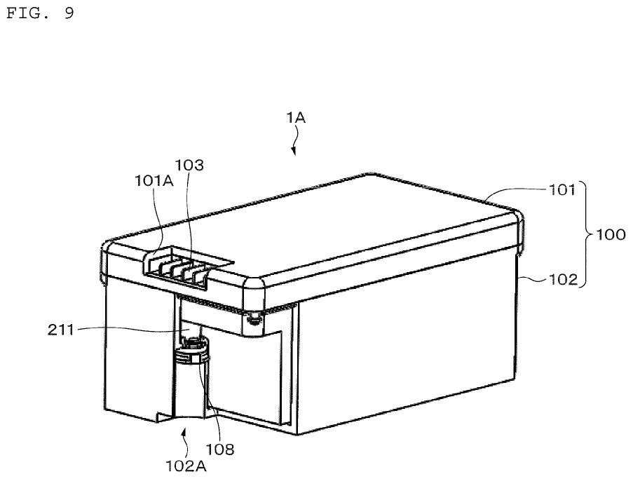

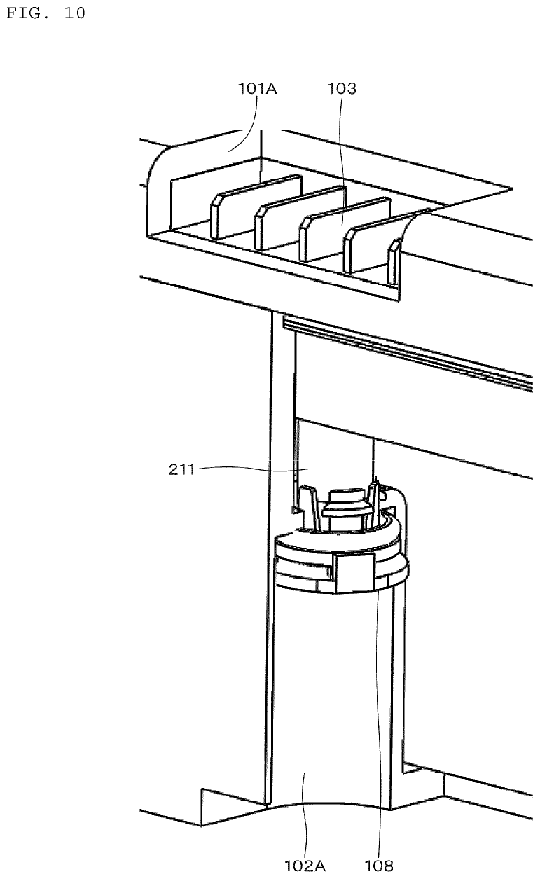

A structure example of a battery pack (battery pack 1A) according to the second embodiment will be described with reference to FIGS. 8 to 10. FIG. 8 is an exploded perspective view of a battery pack 1A, FIG. 9 is a view showing an internal configuration of the battery pack 1 by cutting out a part of the battery pack 1, and FIG. 10 is an enlarged view of a part of FIG. 9.

The battery pack 1A has an inner case 200 provided inside an exterior case 100, and has a double structure. The inner case 200 includes an inner upper case 201 having a rectangular shape in top view and a lid shape, and an inner lower case 202 having a case shape with an open upper surface. A connector 103, a circuit board 105, and a battery unit 15 are stored in the inner case 200. In the inner upper case 201, a cut-out 201A is formed at a position corresponding to the hole portion 101A of the exterior upper case 101. As shown in FIG. 9, the connector 103 is exposed to the outside via the cut-out 201A and the hole portion 101A.

A protrusion 210 protruding outward is formed on an upper side of one side surface of the inner lower case 202. A restricting member 211 extending downward is provided on a bottom surface of the protrusion 210. As described above, in the second embodiment, the restricting member 211 is provided in a part of the inner case 200. The restricting member 211 has a columnar shape, for example.

As shown in FIGS. 9 and 10, the pressure regulating valve 108 is inserted and attached from the recess 102A of the exterior lower case 102. An attachment mode of the pressure regulating valve 108 and the function of the restricting member 211 are similar to those of the first embodiment. That is, the restricting member 211 of the inner case 200 is disposed inside three fitting claws 184A to 184C, so that the restricting member 211 limits the movable range of the fitting claws 184A to 184C. This prevents the pressure regulating valve 108 from coming off from the exterior case 100.

According to an embodiment, in the configuration in which the battery unit 15 is stored in the inner case, it is possible to realize the structure for reliably preventing the pressure regulating valve 108 from coming off. Since the restricting member 211 is provided in the inner case 200, the restricting member 211 can be easily disposed inside the fitting claws 184A to 184C, and the number of work steps at the time of manufacturing can be reduced.

One or more embodiments of the present application have been specifically described above; however, the contents of the present application are not limited to the above-described embodiments, and various modifications of the present application can be made.

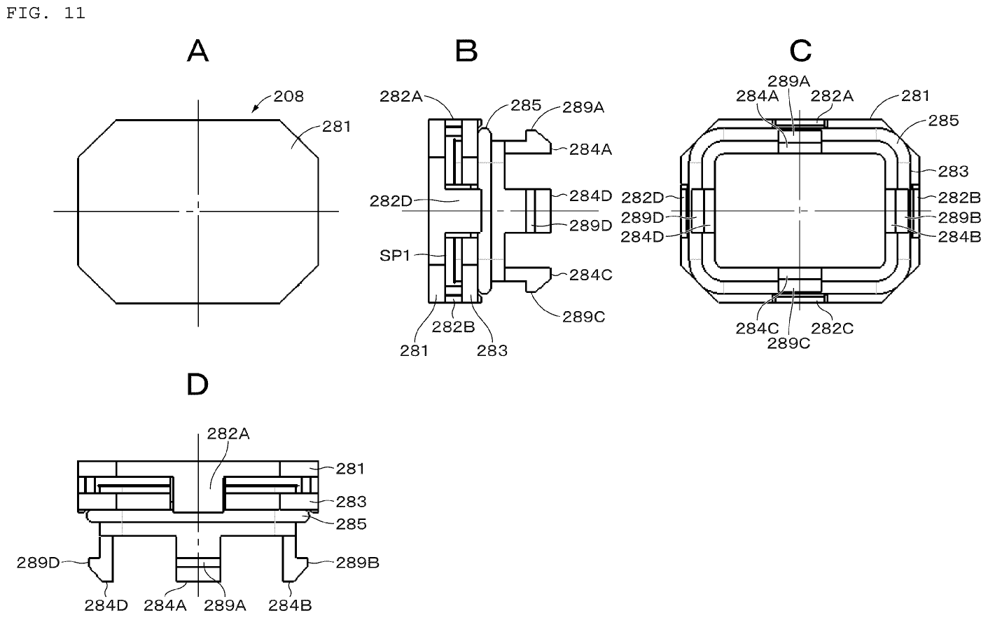

The pressure regulating valve may have a polygonal section, and a plurality of fitting claws may be arranged along the polygonal sectional shape. FIGS. 11A to 11D show a configuration example of a pressure regulating valve (pressure regulating valve 208) according to an embodiment. For example, as shown in FIG. 11A, the pressure regulating valve 208 has a rectangular base 281 having a polygonal shape in which the vicinity of the corner is cut. Protrusions 282A to 282D are formed on each of four sides of the base 281. A frame member 283 is supported by the four protrusions 282A to 282D. An O-ring 285 is attached to an outer peripheral side of a surface of the frame member 283 opposite to an opposing surface facing the base 281. Four fitting claws 284A to 284D are provided from an inner peripheral side of the surface of the frame member 283 opposite to the opposing surface facing the base 281. The fitting claws include locking pieces 289A to 289D, respectively.

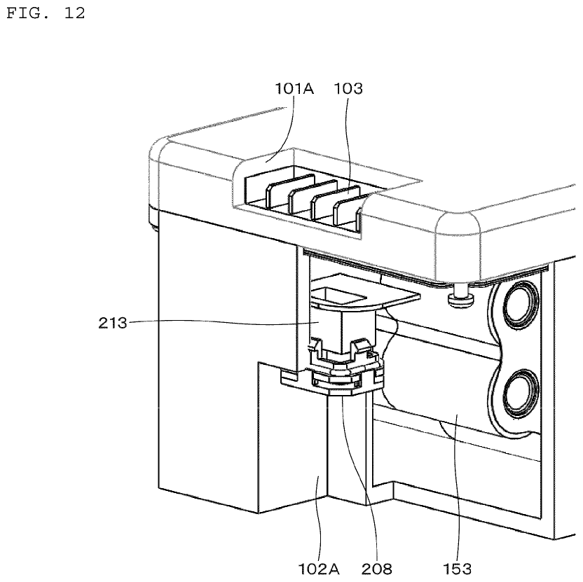

The restricting member according to an embodiment has a polygonal columnar shape. For example, as shown in FIG. 12, the restricting member (restricting member 213) has a quadrangular prism shape. In an embodiment, the restricting member 213 is disposed inside the fitting claws 284A to 284D. As a result, a movable range of the fitting claws 284A to 284D is limited by the restricting member 213, and the come-off preventing structure similar to that of an embodiment is realized.

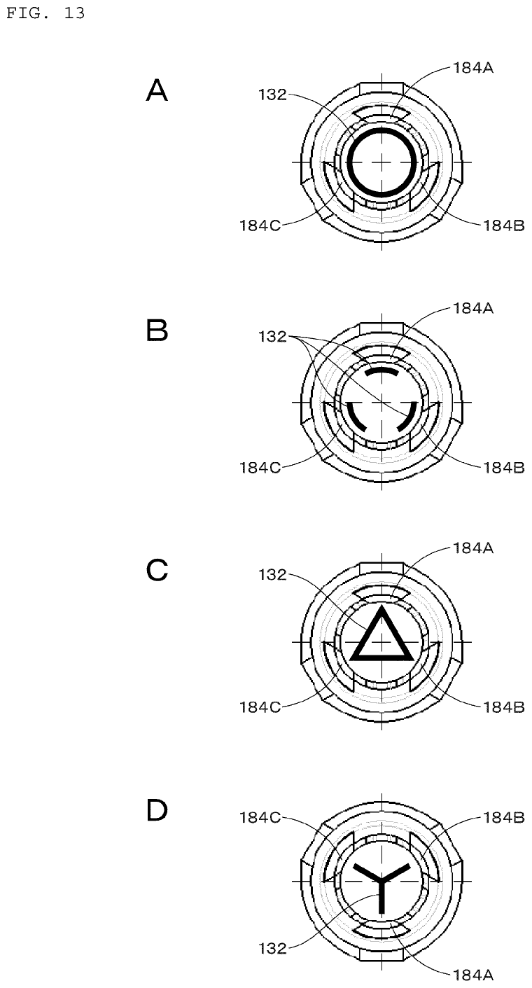

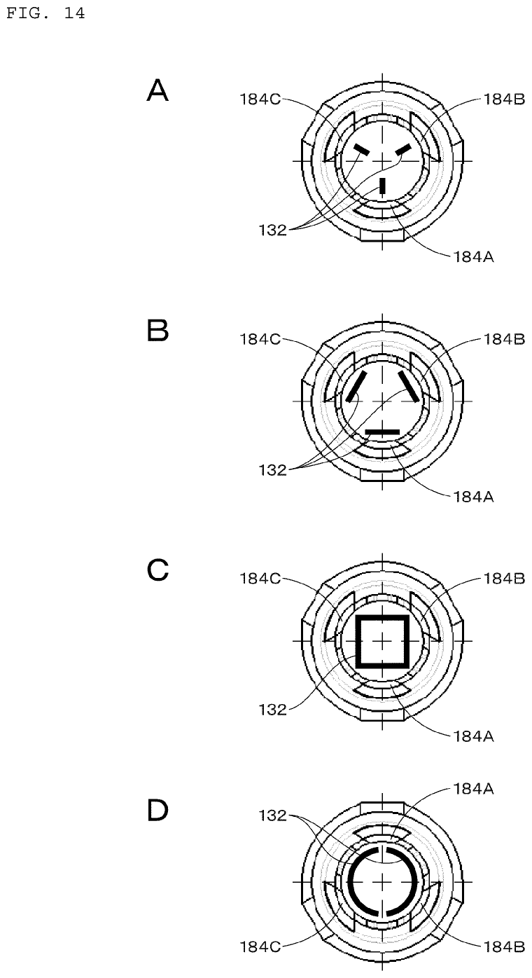

Next, a modification of the shape of the restricting member 132 will be described with reference to FIGS. 13 and 14 according to an embodiment. FIG. 13A is an example in which the restricting member 132 has a columnar shape according to an embodiment. As shown in FIG. 13B, the restricting member 132 may be three independent plate-like members provided inside each of the three fitting claws 184A to 184C. As shown in FIG. 13C, the restricting member 132 may have a triangular prism shape. In this case, the vicinity of the corner of the restricting member 132 is disposed inside the three fitting claws 184A to 184C, and the movable range of each fitting claw is limited near the corner of the restricting member 132. As shown in FIG. 13D, the restricting member 132 may have a Y-shaped sectional shape. In this case, a tip of the restricting member 132 is disposed inside each fitting claw.

As shown in FIG. 14A, the restricting member 132 may be a member extending in a direction substantially orthogonal to each fitting claw, or as shown in FIG. 14B, may be a member extending in a direction substantially parallel to an inner surface of each fitting claw. As shown in FIG. 14C, the restricting member 132 may be a quadrangular prism member. As shown in FIG. 14D, the restricting member 132 may be two members having a semicircular section.

As described above, various shapes can be adopted as the shape of the restricting member 132. Since the restricting member 132 is a member that restricts the movable range of the three fitting claws 184A to 184C, the restricting member preferably has a shape that hardly deflects, specifically, a closed shape. From this viewpoint, among the exemplified shapes, the shapes shown in FIGS. 13A, 13C, and 14C are preferable.

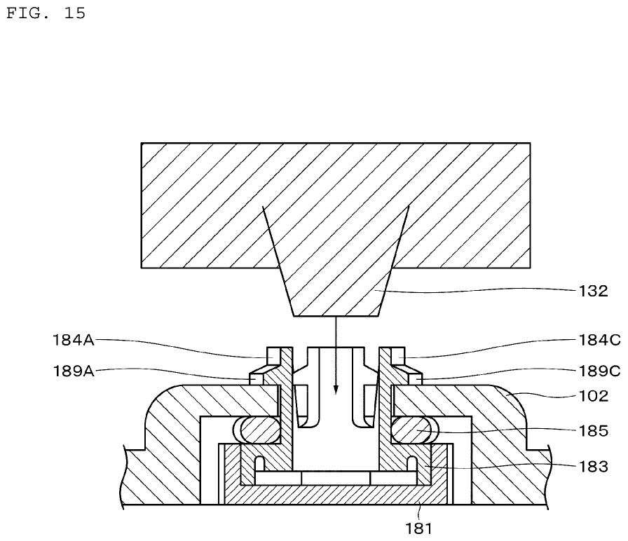

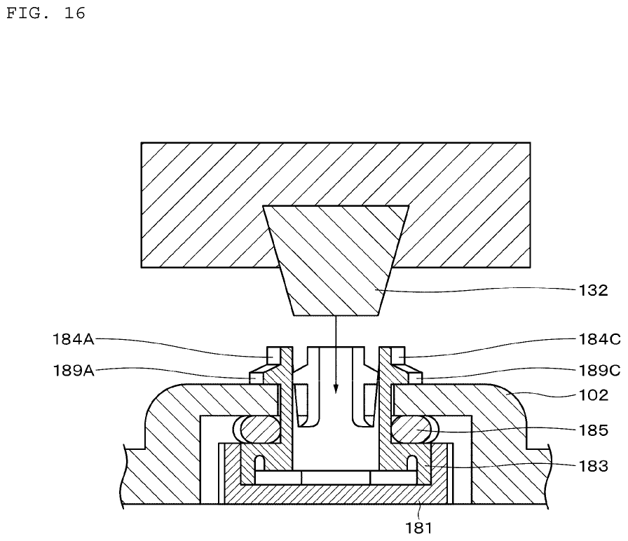

As shown in FIG. 15, the restricting member 132 may be one component integrally formed with an internal structure disposed in the exterior case 100. As shown in FIG. 16, the restricting member 132 may be a dedicated component different from the internal structure. In such a case, the restricting member 132 is attached to the internal structure by an appropriate method such as welding, fitting, or bonding.

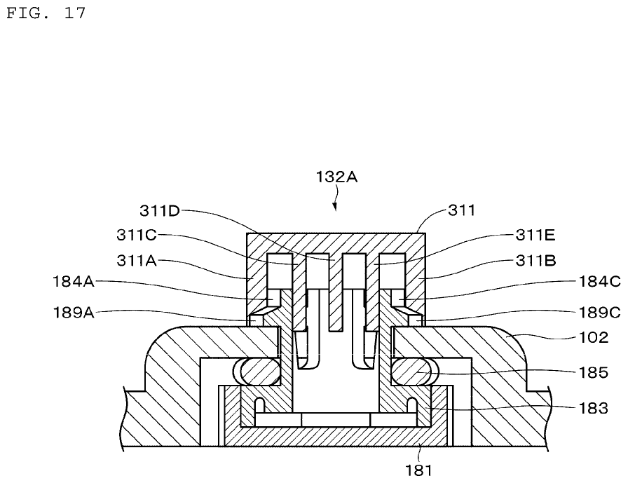

FIG. 17 is a view showing a restricting member (restricting member 132A) according to an embodiment. The restricting member 132A according to an embodiment is provided integrally with the exterior lower case 102 inside the exterior case 100, more specifically, the exterior lower case 102. As shown in FIG. 17, the restricting member 132A includes a base 311, and the base 311 is connected to the exterior lower case 102 by two connecting portions 311A and 311B. From the base 311, elastically deformable ribs 311C to 311E are planted downward. When the operation of inserting the pressure regulating valve 108 is performed, for example, the rib 311C deflects inward, and the fitting claw 184A is inserted between the connecting portion 311A and the rib 311C. When the fitting claw 184A is inserted a certain amount or more, the fitting claw 184A is sandwiched and supported between the connecting portion 311A and the rib 311C by the restoring force of the rib 311C. As a result, when an impact is applied, the movement of the fitting claw 184A toward the inside is restricted, so that it is possible to realize the come-off preventing structure similar to that of an embodiment.

Other modifications will be described according to an embodiment. The number of the fitting claws may be other than three. A plurality of the pressure regulating valves may be attached, and an attachment position of the pressure regulating valve can be appropriately changed. The configurations of the restricting member and the pressure regulating valve may be suitably changed.

The matters described in the above-described embodiments including modifications can be appropriately combined. In addition, the materials, processes, and the like described herein are merely examples, and the contents of the present application are not limited to the exemplified materials and the like.

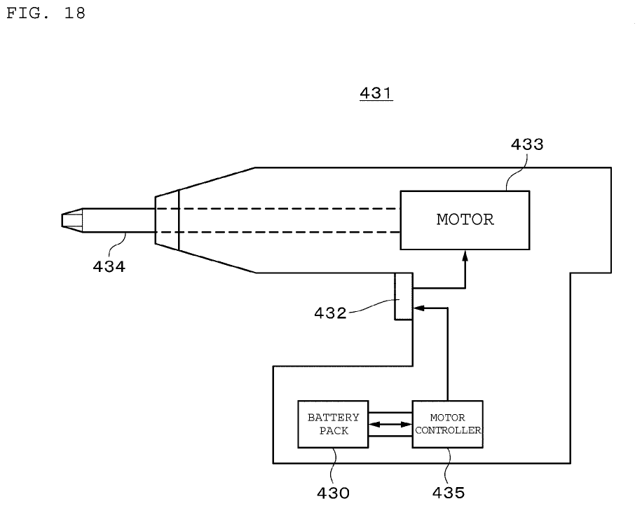

Next, application examples to which the battery pack of the present application can be applied will be described according to an embodiment. First, an example of an electric driver as a power tool to which the present application can be applied will be schematically described with reference to FIG. 18. An electric driver 431 is provided with a motor 433 that transmits rotational power to a shaft 434 and a trigger switch 432 operated by a user. A battery pack 430 and a motor controller 435 according to the present application are housed in a lower housing of a handle of the electric driver 431. The battery pack 430 is built in the electric driver 431 or is detachable.

Each of the battery pack 430 and the motor controller 435 may be provided with a microcomputer (not shown) so that charge/discharge information of the battery pack 430 can be communicated with each other. The motor controller 435 can control operation of the motor 433 and cut off power supply to the motor 433 at the time of abnormality such as overdischarge.

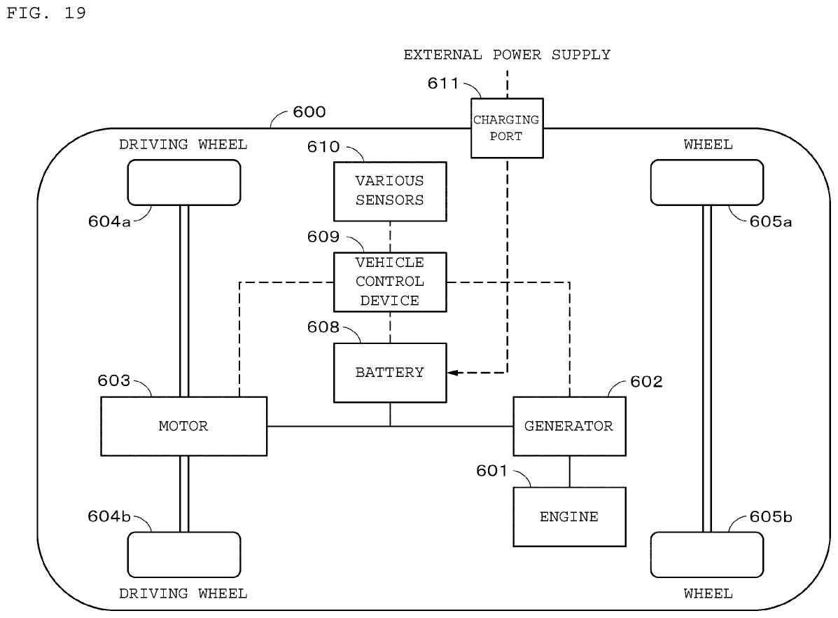

As an example in which the present application is applied to an electric vehicle power storage system, FIG. 19 schematically shows a configuration example of a hybrid vehicle (HV) employing a series hybrid system. The series hybrid system is a car travelling with an electric power driving force converter using electric power generated by a generator powered by an engine or electric power obtained by temporarily storing the generated electric power in a battery.

An engine 601, a generator 602, an electric power driving force converter (DC motor or AC motor, hereinafter, it is simply referred to as the “motor 603”), a driving wheel 604a, a driving wheel 604b, a wheel 605a, a wheel 605b, a battery 608, a vehicle control device 609, various sensors 610, and a charging port 611 are mounted in the hybrid vehicle 600. As the battery 608, the battery pack of the present application or a power storage module on which a plurality of the battery packs of the present application are mounted can be applied.

The motor 603 is operated by the electric power of the battery 608, and a rotating force of the motor 603 is transmitted to the driving wheels 604a and 604b. The electric power generated by the generator 602 can be stored in the battery 608 by the rotating force generated by the engine 601. The various sensors 610 control an engine speed through the vehicle control device 609, or control an opening degree of a throttle valve (not shown).

When the hybrid vehicle 600 is decelerated by a brake mechanism (not shown), a resistance force during the deceleration is added as a rotating force to the motor 603, and regenerative electric power generated due to this rotating force is stored in the battery 608. The battery 608 can be charged by being connected to an external power supply via the charging port 611 of the hybrid vehicle 600. Such an HV vehicle is referred to as a plug-in hybrid vehicle (PHV or PHEV).

The battery pack according to the present application can also be applied to a downsized primary battery and used as a power supply of a tire pressure monitoring system (TPMS) built in wheels 604 and 605.

Although a series hybrid vehicle has been described above as an example, the present application is also applicable to a parallel system using an engine and a motor together or a hybrid vehicle in which a series system and a parallel system are combined. In addition, the present application is also applicable to an electric vehicle (EV or BEV) and a fuel cell vehicle (FCV) that travel only by a drive motor not using an engine.

### DESCRIPTION OF REFERENCE SYMBOLS

1, 1A: Battery pack
15: Battery unit
100: Exterior case
102A: Recess
108, 208: Pressure regulating valve
132, 132A, 213: Restricting member
152: First cell holder
153: Second cell holder
184A, 184B, 184C: Fitting claw
284A, 284B, 284C, 284D: Fitting claw
311C, 311D, 311E: Rib

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery pack comprising:
an exterior case;
a battery unit; and
an attachment member attached from outside of the exterior case, wherein
the attachment member has a plurality of claw portions,
the attachment member is attached to the exterior case by the plurality of claw portions,
a restricting member that restricts a movable range of the claw portion is provided inside the exterior case, and
the restricting member is configured as a member separate from the exterior case.

2. The battery pack according to claim 1, wherein the attachment member is fixed to a recess provided in the exterior case.

3. The battery pack according to claim 1, wherein the attachment member is a pressure regulating member including an air-permeable membrane.

4. The battery pack according to claim 1, wherein
the attachment member has a circular section, and the plurality of claw portions are arranged along a sectional shape of the attachment member, and
the restricting member is provided inside the plurality of claw portions.

5. The battery pack according to claim 4, wherein the restricting member has a columnar shape.

6. The battery pack according to claim 1, wherein
the attachment member has a polygonal section, and the plurality of claw portions are arranged along a sectional shape of the attachment member, and
the restricting member is provided inside the claw portion.

7. The battery pack according to claim 6, wherein the restricting member has a polygonal columnar shape.

8. The battery pack according to claim 1, further comprising a battery holder that stores the battery, wherein
the restricting member is provided at a part of an outer surface of the battery holder.

9. The battery pack according to claim 1, wherein
an inner case in which the battery unit is stored is provided inside the exterior case, and
the restricting member is provided at a part of the inner case.

10. A battery pack comprising:
an exterior case;
a battery unit; and
an attachment member attached from outside of the exterior case, wherein
the attachment member has a plurality of claw portions,
the attachment member is attached to the exterior case by the plurality of claw portions, and
a restricting member that restricts a movable range of the plurality of claw portions is integrally provided inside the exterior case, and the restricting member is an elastically deformable rib.

11. A power tool comprising the battery pack according to claim 1.

12. An electric vehicle comprising the battery pack according to claim 1.
